(19) United States
(12) Patent Application Publication
(10) Pub. No.: US 2025/0392112 A1
(43) Pub. Date: Dec. 25, 2025

(54) PULL-UP CIRCUIT FOR CIRCUIT BREAKER CONTACTS

(71) Applicant: Vertiv Corporation, Westerville, OH (US)

(72) Inventors: Luigi BALMA, Bologna (IT); Paolo COLOMBARI, Bologna (IT); John Ezzat Fahmy ABDOU, Osteria Grande (IT); Mauro BARBIERI, Bologna (IT)

(21) Appl. No.: 19/242,581

(22) Filed: Jun. 18, 2025

Related U.S. Application Data
(60) Provisional application No. 63/661,700, filed on Jun. 19, 2024.

(51) Int. Cl. H02H 3/08; H02H 1/00

(52) U.S. Cl. CPC H02H 3/08; H02H 1/0007

(57) ABSTRACT

A pull-up circuit for circuit breaker contacts is disclosed. The pull-up circuit of the present disclosure is configured to, under the control of a microcontroller, inject a current into a contact of a circuit breaker to remove the oxidation therefrom (which may cause undesired resistance to current flow). The microcontroller may also perform a measurement to determine current flow through the contact. The activation of the pull-up circuit by the microcontroller may be performed periodically to limit the build-up of oxidation on the contact of the fuse, with each activation lasting for a predetermined time period.

### CROSS REFERENCE TO RELATED APPLICATIONS

This application claims priority to U.S. Provisional Patent Application No. 63/661,700, entitled “Pull-Up Circuit for Circuit Breaker Contacts,” filed Jun. 19, 2024, and which is incorporated by reference herein fully.

### TECHNICAL FIELD

Apparatuses and methods consistent with example embodiments relate to electrical/electronics equipment units, and more particularly to an electrical/electronics power distribution unit with a single piece frame with integrated cable trough, lifting handles, and optional welded base.

### BACKGROUND

Industrial circuit breakers are widely used components in modern electrical systems, designed to protect circuits from overcurrents that can cause damage, inefficiency, or fire hazards. Circuit breakers function as automatic switches that open (or “trip”) when current exceeds a predetermined level. This in turn interrupts current flow to prevent harm to the system(s) which is it protecting. As opposed to fuses, which must be replaced after one use, circuit breakers can be reset and reused. This reusability makes circuit breakers a practical and cost-effective solution for industrial applications. Accordingly, circuit breakers may be widely used for protecting the safety and functionality of electrical infrastructure such as manufacturing, power generation, and construction.

Industrial circuit breakers may come in various types, including Miniature Circuit Breakers (MCB), Molded Case Circuit Breakers (MCCB), and Residual Current Circuit Breakers (RCCB), each tailored to specific requirements and capacities. Some circuit breakers may include features such as adjustable trip settings and/or a range of interrupt rating.

### SUMMARY

A pull-up circuit for circuit breaker contacts is disclosed. The pull-up circuit of the present disclosure is configured to, under the control of a microcontroller, inject a current into a contact of a circuit breaker to remove the oxidation therefrom (which may cause undesired resistance to current flow). The microcontroller may also perform a measurement to determine current flow through the contact. The activation of the pull-up circuit by the microcontroller may be performed periodically to limit the build-up of oxidation on the contact of the fuse, with each activation lasting for a predetermined time period.

In some embodiments, a system includes a pull-up circuit having a pull-up terminal that may be connected to a terminal of the circuit breaker, and further including a measurement terminal. A microcontroller in communication with the pull-up circuit is configured to assert an activation signal. The pull-up circuit is configured to draw a current at a first current value, in response to assertion of the activation signal, from the terminal of the circuit breaker, and further configured to cause the current to change to a second current value. The microcontroller is further configured to determine, via the measurement terminal, the second value of the current

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a block diagram of a system including a circuit breaker, a pull-up circuit, and a microcontroller, according to the principles of the present disclosure.

FIG. 2 is a schematic diagram of a pull-up circuit according to the principles of the present disclosure.

FIG. 3 is a diagram illustrating operation of an alternative pull-up circuit according to the principles of the present disclosure.

FIG. 4 is a flow diagram illustrating a method for operating a pull-up circuit using a microcontroller according to the principles of the present disclosure.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

It may be understood that the example embodiments described herein may be considered in a descriptive sense only and not for purposes of limitation. Descriptions of features or aspects within each example embodiment may be considered as available for other similar features or aspects in other example embodiments.

Industrial circuit breakers typically include auxiliary contact, which are used to monitor their position (open or closed). Such contacts are often made using low quality metals, such as silver-nickel. Over time, such metal are susceptible to oxidation. This can lead to high resistance in the electrical contacts of a circuit breaker, particularly if its position changes on an infrequent basis.

Manufacturers of circuit breakers often times specify a minimum amount of current that can flow into a contact in order to burn through a partial oxidation layer and thus lower the contact resistance. One technique to facilitate burning through the oxidation layer involves a capacitor connected in parallel with a circuit breaker. The capacitor may be charged while the circuit breaker is open. When the circuit breaker is closed, the capacitor may discharge while providing enough current to burn through the oxidation layer (this may be referred to as “wetting” the contact). However, this technique requires changing between the open and closed positions of the circuit breaker. Since the position of a given circuit breaker may seldom change (e.g., due to being part of a mission critical application), this technique may be insufficient to deal with the oxidation that may occur on the circuit breaker contacts.

The present disclosure provides a circuit and method for periodically applying a current to contacts (or terminals) of a circuit breaker in order to reduce or eliminate an oxidation layer that may otherwise accumulate. In some embodiments, a pull-up circuit includes a pull-up terminal coupled to a terminal (contact) of a circuit breaker. A microcontroller in communication with the pull-up circuit may periodically activate the pull-up circuit by asserting an activation signal. In response to assertion of the activation signal, the pull-up circuit may generate a pull-up voltage that causes it to draw a current from (and thus through) the terminal of the circuit breaker to which it is coupled. The current may initially be drawn at a first value that may reduce or eliminate oxidation on the terminal of the circuit breaker. Over time, the current may change to a second (e.g., smaller) value. The microcontroller may include a measurement input coupled to the pull-up circuit, and may thus take a measurement of the current. In some embodiments, the measured current may be a value of the second current, with the measurement being carried out near the end of a predetermined time period just prior to the microcontroller de-asserting the activation signal. Response to de-assertion of the activation signal, the pull-up circuit may discontinue drawing current from the terminal of the circuit breaker.

The process above may be carried out periodically to prevent the accumulation of oxidation on the corresponding terminal of the circuit breaker. In each instance, the activation signal may be asserted for a predetermined time period. Furthermore, the process described above may be carried out without the need to change the position of the circuit breaker (e.g., from open to closed and/or vice versa).

The circuits and method of the present disclosure may allow the removal of oxidation from a terminal of a circuit breaker that might otherwise be allowed to accumulate over time. Furthermore, the circuits and methods of the present disclosure may obviate the need for more expensive metals that are not susceptible to (or less susceptible to) oxidation. Additionally, the circuits and methods described herein may remove oxidation without requiring a change to the position (open to closed or vice versa) of the circuit breaker. Embodiments of the circuits and methods are now discussed in further detail below.

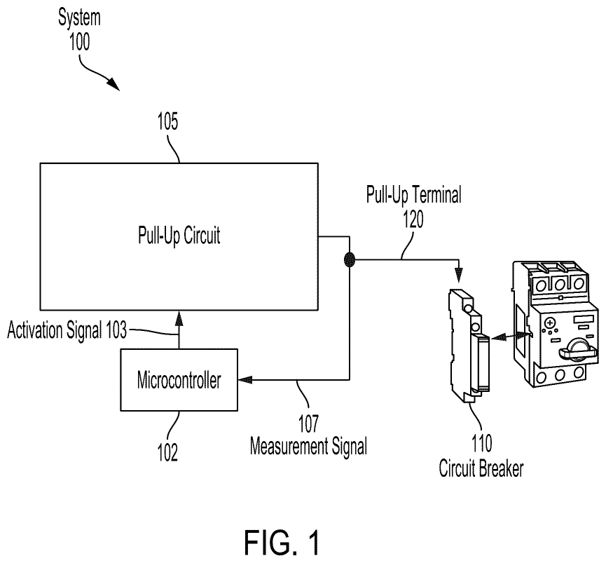

FIG. 1 is a block diagram of a system including a circuit breaker, a pull-up circuit, and a microcontroller. In some embodiments, system 100 includes a microcontroller 102 coupled to a pull-up circuit 105. Pull-up circuit 105 is also coupled to circuit breaker 110 via pull-up terminal 120. In this example, pull-up circuit 105 may cause a current between two different values (40 mA and 10 mA in this non-limiting example) to flow through the contact of circuit breaker 110 to which pull-up terminal 120 is coupled. The currents may be used to both reduce or eliminate any oxidation that may have occurred on the contact of the circuit breaker, as well as to provide a basis of measurement to ascertain that the resistance of the contact is within specifications.

Microcontroller 102 may periodically activate pull-up circuit 105 by asserting activation signal 103. In response to assertion of the activation signal 103, pull-up circuit 105 may begin to cause current to flow through pull-up terminal 120, and thus through the contact of circuit breaker 110 to which it is coupled. The activation signal may be held as asserted by microcontroller 102 for a predetermined period. In some embodiments, microcontroller 102 may perform a sample measurement near the end of the predetermined period, using measurement signal 107. Using this measurement, microcontroller 102 may determine if the current is within specified limits. In some embodiments, microcontroller 102 may generate additional signals to alert an operator or technician if the current is not within specified limits. At the end of the predetermined period, microcontroller 102 may de-assert activation signal 103.

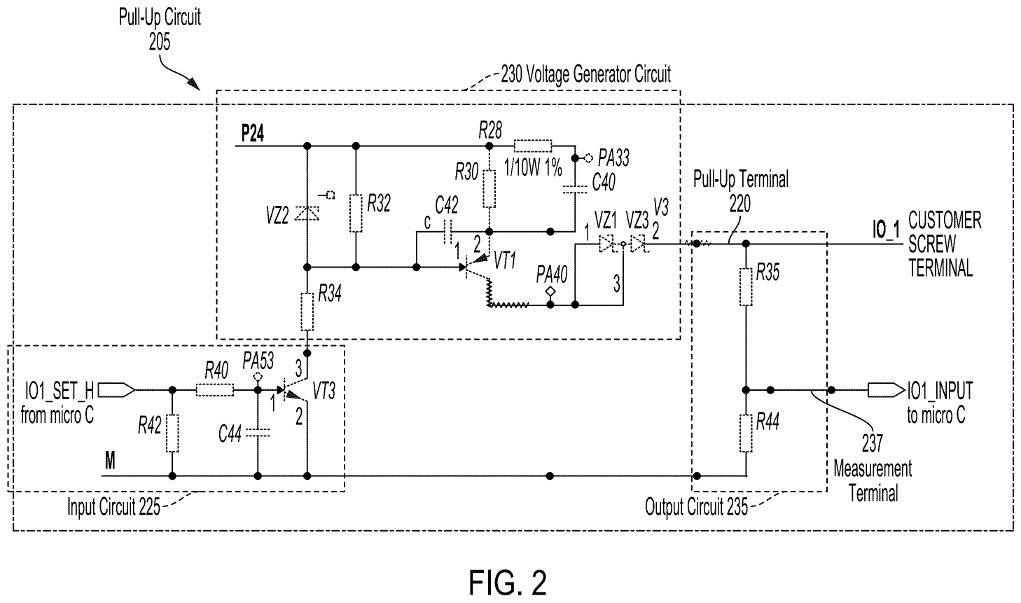

FIG. 2 is a schematic diagram of a pull-up circuit. In some embodiments, pull-up circuit 205 includes an input circuit 225, a voltage generator circuit 230, and an output circuit 235. Input circuit 225 may be configured to receive an activation signal (shown here as IO1_SET_H) from a microcontroller that, when asserted, cause voltage generator circuit 230 to generate a voltage on pull-up terminal 220. Generating the voltage may in turn cause current to flow through a contact of a circuit breaker to which pull-up terminal 220 is coupled. Output circuit 235 may generate, on measurement terminal 237, a measurement signal that may be provided to the microcontroller that may be used to determine the current flowing through the contact. Pull-up circuit 205 may be used with, e.g., a microcontroller such as microcontroller 102 of FIG. 1 in the same or similar configuration in order to generate current to remove an oxidation layer from a contact as well as to measure the current through the contact to ensure that it is within specified limits.

Input circuit 225 includes resistors R40 and R42, capacitor C44, and a transistor VT3. In some embodiments, transistor VT3 is a bipolar transistor, and more particularly, and NPN transistor. When the activation signal is asserted, VT3 may draw current though its collector terminal, and thus generating a pull-down path through R34 of voltage generator circuit 230. When the activation signal is de-asserted, the voltage on the base terminal of transistor VT3 may be such that the device is in cutoff, with no current flowing between its collector and emitter.

Voltage generator circuit 230 includes resistors R28, R30, R32, and R34, capacitors C40 and C42, diodes VZ1, VZ2, and VZ3 (zener diodes in this implementation), and transistor VT1. As shown here, transistor VT1 is a bipolar PNP transistor. It is noted however that embodiments are possible and contemplated in which other types of transistors are used in pull-up circuit 205. For example, embodiments in which VT1 is implemented as a PMOS transistor while VT3 is implemented as an NMOS transistor are possible and contemplated.

When transistor VT3 generates the pull-down path through R34, the voltage on the junction of R34 and the base of VT1 may fall. When the voltage on its base falls sufficiently, VT1 may become forward biased, with a pull-up path being generated through its collector and emitter terminals. This in turn generates a voltage on pull-up terminal 220 that causes current to flow through a contact of a circuit breaker to which this terminal is coupled.

When initially activated, voltage generator circuit 230 may generate the voltage on pull-up terminal 220 at a first voltage value, thereby causing current to flow at a first current value. During the time that the activation signal is asserted, capacitors C40 and C42 will discharge, and thus the voltage on pull-up terminal 220 will decrease. Correspondingly, the current generated via pull-up terminal 220 will also decrease until it reaches a second current value. This second current value may be a steady-state value, and may remain as such until the activation signal is de-asserted.

When the activation signal is de-asserted and VT3 enters cutoff, the voltage on the base of VT1 may rise sufficiently to cause that device to also enter cutoff. Thereafter, the pull-up path is no longer present, and thus no further current is generated by a voltage on pull-up terminal 220. Meanwhile, with VT1 and VT3 in cutoff, capacitors C40 and C42 are charged by a supply voltage on node P24, via resistors R28 and R30. The charge on capacitor C42 may cause VT1 to remain in cutoff until the next activation of VT3. Meanwhile, the charge on C40 may be stored until VT3 is active, discharging thereafter to vary the voltage on pull-up terminal 220.

Output circuit 235 includes a voltage divider circuit comprising resistors R35 and R44, which are coupled in series between pull-up terminal 220 and a ground node. At the junction of R35 and R44 is a measurement terminal where a measurement signal is generated as a voltage, with the generated voltage corresponding to the current flowing through the contact of the circuit breaker and pull-up terminal 220. This measurement signal may be provided to the microcontroller to determine the current through the contact. In some embodiments, the measurement may be performed near the end of the predetermined time, just prior to the microcontroller de-asserting the activation signal. However, embodiments are possible and contemplated in which the microcontroller provides a continuous measurement of the current in order to determine the response of voltage generator circuit 230 and the current through the correspondingly coupled contact of the circuit breaker.

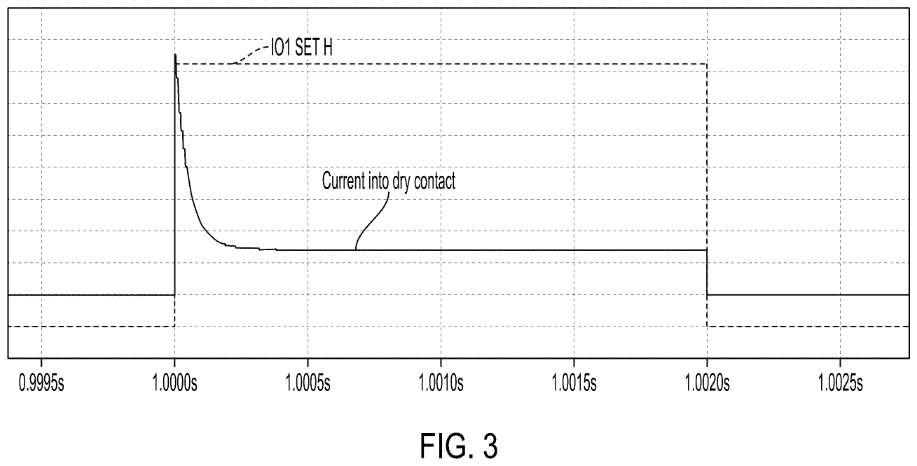

FIG. 3 is a diagram illustrating operation of a pull-up circuit. In particular, FIG. 3 illustrates an example current generated in response to assertion of the activation signal for the pull-up circuit of FIG. 2. In the illustrated example, in response to the assertion of the activation signal (IO1_SET_H), the current initially rises to a first current value, or a peak value. The peak value may be sufficient to remove or eliminate any oxidation that may have built up on the contact of the circuit breaker during the time that the activation signal was de-asserted.

After initially rising to its peak value, the current begins to fall as the capacitors of the circuit discharge until it reaches a second current value, or steady state value. This value may be reached after the capacitors of voltage generator circuit 230 illustrated in FIG. 2 have discharged while the activation signal otherwise remains asserted. As noted above, in various embodiments, a measurement of the current may be performed at some point during the time period that the activation signal is asserted. In some embodiments, this measurement may be taken just prior to de-assertion of the activation signal to ensure that the steady state current is sufficient (and thus, resistance from any oxide build-up on the contact of the circuit breaker is low enough so as to not adversely affect its operation). After de-assertion of the activation signal, as shown in FIG. 3, the current may fall to zero or to a negligible value.

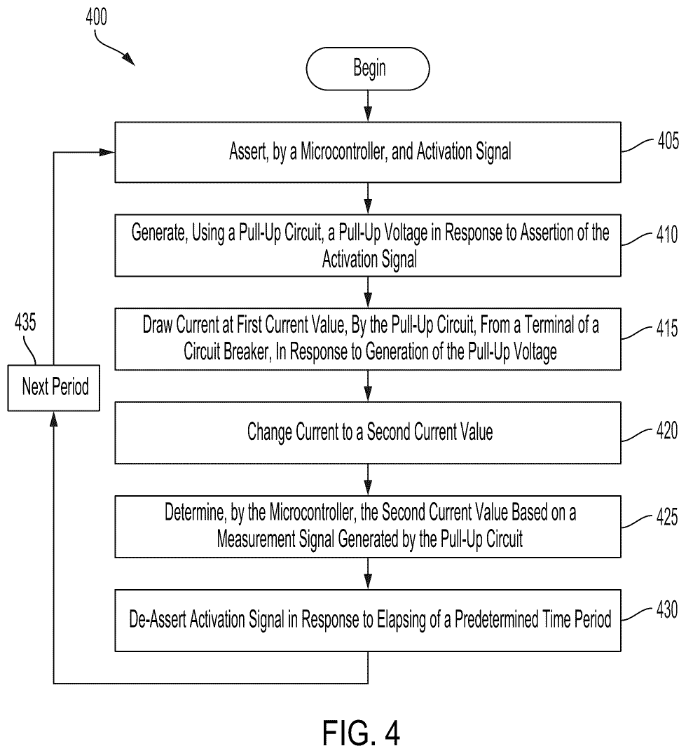

FIG. 4 is a flow diagram illustrating a method for operating a pull-up circuit using a microcontroller. Method 400 may be carried out by various embodiments of the circuits and microcontroller discussed above. Embodiments of hardware capable of carrying out Method 400, but not otherwise disclosed herein, are considered to fall within the scope of this disclosure.

Method 400 includes asserting, by a microcontroller, an activation signal (block 405). In response to the asserting, the method further includes generating, using a pull-up circuit, a pull-up voltage in response to asserting the activation signal (block 410). The method further includes, in response to generation of the pull-up voltage, drawing a current at a first current value, by the pull-up circuit, from a terminal of a circuit breaker and in response to generation of the pull-up voltage (block 415). Thereafter, the method includes changing the current to a second current value (block 420). The method also includes determining, by the microcontroller, the second current value based on a measurement signal generated by the pull-up circuit (block 425) and subsequently de-asserting the activation signal in response to elapsing of a predetermined time has elapsed (block 430). Subsequent to the de-assertion, the method progresses to the next period (block 435), at which the various method steps are repeated beginning at a next scheduled time.

While example embodiments have been described with reference to the figures, it will be understood by those of ordinary skill in the art that various changes in form and details may be made therein without departing from the spirit and scope as defined by the following claims.

What is claimed is:

1. An apparatus comprising:
a circuit breaker;
a pull-up circuit having a pull-up terminal coupled to a terminal of the circuit breaker and a measurement terminal; and
a microcontroller in communication with the pull-up circuit, wherein the microcontroller is configured to assert an activation signal, and wherein the pull-up circuit is configured to:
draw a current at a first current value, in response to assertion of the activation signal, from the terminal of the circuit breaker; and
cause the current to change to a second current value; and
wherein the microcontroller is configured to determine, via the measurement terminal, the second value of the current.

2. The apparatus of claim 1, wherein the microcontroller is further configured to:
periodically assert the activation signal for a predetermined time;
de-assert the activation signal in response to elapsing of the predetermined time; and
determine the second current value prior to the predetermined time elapsing, wherein the second current value is less than the first current value.

3. The apparatus of claim 1, wherein the pull-up circuit includes:
an input circuit coupled to receive the activation signal from the microcontroller;
a voltage generator circuit configured to generate a pull-up voltage; and
an output circuit configured to draw the current via the pull-up terminal and further configured to generate a measurement signal on the measurement terminal.

4. The apparatus of claim 3, wherein the input circuit includes a first transistor configured to be activated in response to assertion of the activation signal.

5. The apparatus of claim 4, wherein the voltage generator circuit includes a second transistor configured to be activated in response to activation of the first transistor.

6. The apparatus of claim 5, wherein the voltage generator is configured to generate the pull-up voltage in response to activation of the second transistor.

7. The apparatus of claim 5, wherein the first transistor and the second transistor are bipolar transistors.

8. The apparatus of claim 5, wherein the pull-up circuit includes a first capacitor configured to inhibit activation of the second transistor when the first transistor is inactive, and further includes a second capacitor configured to discharge through the second transistor when the second transistor is active.

9. The apparatus of claim 3, wherein the output circuit includes a voltage divider having first and second resistors coupled in series between the pull-up terminal and a ground terminal, wherein the measurement terminal is coupled to a junction of the first and second resistors.

10. The apparatus of claim 9, wherein the microcontroller is configured to determine the second value of the current based on a voltage of the measurement signal on the measurement terminal.

11. A method comprising:
asserting, by a microcontroller, an activation signal;
generating, using a pull-up circuit, a pull-up voltage in response to asserting the activation signal;
drawing a current at a first current value, by the pull-up circuit, from a terminal of a circuit breaker and in response to generation of the pull-up voltage;
changing the current to a second current value;
determining, by the microcontroller, the second current value based on a measurement signal generated by the pull-up circuit; and
de-asserting the activation signal in response to elapsing of a predetermined time has elapsed.

12. The method of claim 11, further comprising:
periodically asserting, using the microcontroller, the activation signal for a predetermined time;
de-asserting the activation signal in response to elapsing of the predetermined time; and
determining, using the microcontroller, the second current value prior to the predetermined time elapsing, wherein the second current value is less than the first current value.

13. The method of claim 11, further comprising:
receiving the activation signal, at an input circuit, from the microcontroller;
generating, using a voltage generator circuit of the pull-up circuit, a pull-up voltage;
drawing current, using an output circuit, via a pull-up terminal of the pull-up circuit; and
generating, using the output circuit, a measurement signal on a measurement terminal of the pull-up circuit.

14. The method of claim 13, further comprising:
activating a first transistor of the input circuit in response to assertion of the activation signal; and
activating a second transistor of the voltage generator circuit in response to activation of the first transistor.

15. The method of claim 14, further comprising:
generating the pull-up voltage in response to activation of the second transistor, wherein the first and second transistors are bipolar transistors; and
inhibiting activation of the second transistor, using a first capacitor of the pull-up circuit, when the first transistor is inactive; and
discharging a second capacitor of the pull-up circuit, through the second transistor, when the second transistor is active.

16. The method of claim 13, wherein the output circuit includes a voltage divider having first and second resistors coupled in series between the pull-up terminal and a ground terminal, and wherein the method further comprises generating the measurement signal on a junction of the first and second resistors, wherein the junction of the first and second resistors is coupled to the measurement terminal.

17. The method of claim 16, further comprising determining, using the microcontroller, the second value of the current based on a voltage of the measurement signal.

18. A system comprising:
a circuit breaker;
a microcontroller circuit configured to cause generation of a measurement signal to cause a measurement of a current through a terminal of the circuit breaker; and
a pull-up circuit including:
an input circuit coupled to receive an activation signal from the microcontroller to initiate the measurement of the current;
a voltage generator circuit configured to generate a pull-up voltage; and
an output circuit including an pull-up terminal and a measurement terminal, wherein the output circuit is configured to draw the current via pull-up terminal and further configured to generate a measurement signal on the measurement terminal;
wherein the microcontroller is configured to assert the activation signal, and wherein, in response to receiving the activation signal, the pull-up circuit is configured to:
draw a current at a first current value, in response to assertion of the activation signal, from the terminal of the circuit breaker; and
cause the current to change to a second current value.

19. The system of claim 18, wherein the microcontroller is further configured to:
periodically assert the activation signal for a predetermined time;
de-assert the activation signal in response to elapsing of the predetermined time; and
determine the second current value prior to the predetermined time elapsing, wherein the second current value is less than the first current value.

20. The system of claim 18, wherein the input circuit includes:
a first transistor configured to be activated in response to assertion of the activation signal;
wherein the voltage generator circuit includes a second transistor configured to be activated in response to activation of the first transistor, wherein the voltage generator is configured to generate the pull-up voltage in response to activation of the second transistor;
wherein the output circuit includes a voltage divider having first and second resistors coupled in series between the pull-up terminal and a ground terminal, wherein the measurement terminal is coupled to a junction of the first and second resistors; and
wherein the microcontroller is configured to determine the second value of the current based on a voltage of the measurement signal on the measurement terminal.
